(19) United States
(12) Patent Application Publication
(10) Pub. No.: US 2024/0073241 A1
(43) Pub. Date: Feb. 29, 2024

(54) INTRUSION RESPONSE DETERMINATION

(71) Applicant: BRITISH TELECOMMUNICATIONS PUBLIC LIMITED COMPANY, London (GB)

(72) Inventors: Alfie BEARD, London (GB); Pushpinder CHOUHAN, London (GB); Liming CHEN, London (GB)

(21) Appl. No.: 18/256,438

(22) PCT Filed: Nov. 29, 2021
(86) PCT No.: PCT/EP2021/083435

§ 371 Date: Jun. 8, 2023

(30) Foreign Application Priority Data
Dec. 8, 2020 (GB) 2019259.7

(51) Int. Cl. H04L 9/40

(52) U.S. Cl. CPC H04L 63/1441; H04L 63/1416

(57) ABSTRACT

An intrusion response system (IRS) can include a knowledge-based intrusion response (IR) component configured to use knowledge of prior responses to prior behavior of at least one computer system to determine a first response to behavior of a target computer system; a prediction-based IR component configured to use at least one trained machine learning (ML) model of behavior of the target computer system to predict a second response to the behavior of the target computer system; and a response component configured to determine an output response to the behavior of the target computer system based on at least one of the first response and the second response.

### PRIORITY CLAIM

The present application is a National Phase entry of PCT Application No. PCT/EP2021/083435, filed Nov. 29, 2021, which claims priority from GB Patent Application No. 2019259.7, filed Dec. 8, 2020, each of which is hereby fully incorporated herein by reference.

### TECHNICAL FIELD

The present disclosure relates to intrusion response determination.

### BACKGROUND

It is known to use an intrusion response system (IRS) to generate an action to mitigate an attack on a computer system detected by an intrusion detection system (IDS). Active intrusion response systems automatically generate an action in response to an intrusion, and can therefore be deployed to mitigate high-speed attacks or attacks in large-scale computing environments in an effective manner. However, the consequences of the action can be significant, and can undesirably impact on the performance of a computer system if the action selected by the IRS system is inappropriate for the activity performed.

### SUMMARY

It is desirable to improve intrusion response determination.

According to a first aspect of the present disclosure, there is provided an intrusion response system (IRS) comprising: a knowledge-based intrusion response (IR) component configured to use knowledge of prior responses to prior behavior of at least one computer system to determine a first response to behavior of a target computer system; a prediction-based IR component configured to use at least one trained machine learning (ML) model of behavior of the target computer system to predict a second response to the behavior of the target computer system; and a response component configured to determine an output response to the behavior of the target computer system based on at least one of the first response and the second response.

In some examples, the prediction-based IR component is configured to process behavior data representative of the behavior of the target computer system using the at least one trained ML model, without interacting with the knowledge-based IR component, to predict the second response.

In some examples, the prior behavior of the at least one computer system comprises prior anomalous behavior of the at least one computer system.

In some examples, the knowledge-based IR component is configured to use rules derived from the knowledge, each indicative of an appropriate response to particular behavior of a computer system, to determine the first response. In some of these examples, at least part of the knowledge used by the knowledge-based IR component is stored in a knowledge base comprising a plurality of instances, each corresponding to a respective one of the prior behavior, and the knowledge-based IR component is configured to: identify at least one instance of the plurality of instances corresponding to the behavior of the target computer system; and determine the first response based on the at least one instance and the rules.

In some examples, the prediction-based IR component comprises a plurality of ML models of behavior of the target computer system, and the prediction-based IR component is configured to: predict respective responses to the behavior of the target computer system using each of the plurality of ML models; and select one of the respective responses to use as the second response, wherein optionally the one of the respective responses is selected based on a precision of the one of the respective responses.

In some examples, the response component is configured to determine which of the first and/or second response to use to determine the output response based on a similarity between the behavior of the target computer system and the prior behavior of the at least one computer system. In some of these examples, the response component is configured to determine the output response based on the first response without using the second response in response to determining that the behavior of the target computer system corresponds to the prior behavior of the at least one computer system.

In some examples, the response component is configured to determine which of the first and/or second response to use to determine the output response based on a forecast effect on the target computer system of performance of at least one of the first response or the second response. In some of these examples, the forecast effect of performance of the at least one of the first response or the second response is based on a prior effect on the at least one computer system of prior performance of the at least one of the first response or the second response.

In some examples, the IRS comprises an incident de-duplication component configured to: receive first incident data from a first source, the first incident data comprising a portion representative of an incident within the target computer system; receive second incident data from a second source; determine that the second incident data comprises a portion representative of the same incident as the first incident data; process the second incident data to remove the portion of the second incident data, thereby generating updated second incident data; and generate behavior data representative of the behavior of the target computer system using the first incident data and the updated second incident data.

In some examples, the behavior of the target computer system has been identified as anomalous by an intrusion detection system (IDS).

In some examples, the IRS comprises an authentication component configured to authenticate that the behavior of the target computer system is anomalous.

In some examples, the IRS comprises a response prioritization component configured to prioritize deployment of responses, using the IRS, to respective behavior of the target computer system, based on a forecast effect of the respective behavior on the target computer system.

In some examples, the IRS is configured to update the knowledge useable by the knowledge-based IR system based on an effect of the output response on the target computer system.

In some examples, the behavior of the target computer system comprises anomalous behavior of the target computer system and the IRS is configured to perform a mitigating action represented by the output response to mitigate the anomalous behavior.

In some examples, the behavior of the target computer system comprises anomalous behavior of the target computer system and the IRS is configured to instruct at least one actuator to perform a mitigating action represented by the output response to mitigate the anomalous behavior.

According to a second aspect of the present disclosure, there is provided a telecommunications network comprising the IRS according to any example in accordance with the first aspect of the present disclosure.

According to a third aspect of the present disclosure, there is provided an intrusion response method comprising: determining, using knowledge of prior responses to prior behavior of at least one computer system, a first response to behavior of a target computer system; predicting, using at least one trained machine learning (ML) model of behavior of the target computer system, a second response to the behavior of the target computer system; and determining an output response to the behavior of the target computer system based on at least one of the first response and the second response.

In some examples, the intrusion response method comprises: receiving, from an intrusion detection system, an indication that the behavior of the target computer system is anomalous; and in response to receiving the indication, performing the determining the first response, the predicting the second response and the determining the output response.

In some examples, the intrusion response method comprises training at least one of the ML models based on at least part of the knowledge of the prior responses to the prior behavior of the at least one computer system.

In some examples, the intrusion response method comprises retraining at least one of the ML models based on the behavior of the target computer system and the output response.

In some examples, the intrusion response method comprises updating the knowledge based on the behavior of the target computer system and the output response.

In some examples, the behavior of the target computer system comprises at least one of: network activity within a network or a sensor activation of a sensor.

According to a fourth aspect of the present disclosure, there is provided a computer-readable medium storing thereon a program for carrying out the method of any example in accordance with the third aspect of the present disclosure.

Examples in accordance with the present disclosure may include any novel aspects described and/or illustrated herein, including methods and/or apparatus substantially as herein described and/or as illustrated with reference to the accompanying drawings. The approaches described herein may also be also provided as a computer program and/or a computer program product for carrying out any of the methods described herein and/or for embodying any of the apparatus features described herein, and a computer-readable medium storing thereon a program for carrying out any of the methods and/or for embodying any of the apparatus features described herein. Features described as being implemented in hardware may alternatively be implemented in software, and vice versa.

The disclosure also provides a method of transmitting a signal, and a computer product having an operating system that supports a computer program for performing any of the methods described herein and/or for embodying any of the apparatus features described herein.

Any apparatus feature may also be provided as a corresponding part of a method, and vice versa. As used herein, means plus function features may alternatively be expressed in terms of their corresponding structure, for example as a suitably-programmed processor.

Any feature in one aspect may be applied, in any appropriate combination, to other aspects of the present disclosure. Any, some and/or all features in one aspect can be applied to any, some and/or all features in any other aspect, in any appropriate combination. Particular combinations of the various features described and defined in any aspects of the present disclosure can be implemented and/or supplied and/or used independently.

As used throughout, the word ‘or’ can be interpreted in the exclusive and/or inclusive sense, unless otherwise specified.

### BRIEF DESCRIPTION OF THE DRAWINGS

For a better understanding of the present disclosure, reference will now be made by way of example only to the accompany drawings, in which:

FIG. 1 is a schematic diagram of a system including a computer system according to examples.

FIG. 2 is a flow diagram of an intrusion response method according to examples.

FIG. 3 is a schematic diagram of a system including an intrusion response system according to examples.

FIG. 4 is a schematic diagram of internal components of a computer system according to examples.

### DESCRIPTION

Apparatus and methods in accordance with the present disclosure are described herein with reference to particular examples. The disclosure is not, however, limited to such examples.

Examples herein involve determining responses to behavior of a target computer system using two complementary approaches: a knowledge-based approach that uses knowledge of prior response to prior behavior of at least one computer system (which may or may not include the target computer system), and a prediction-based approach that uses at least one trained machine learning (ML) model of behavior of the target computer system. An output response, for example that may be deployed using an intrusion response system (IRS), is determined based on at least one of a first response obtained with the knowledge-based approach and a second response obtained with the prediction-based approach. Examples herein therefore leverage the benefits of both knowledge-based and prediction-based approaches to determine appropriate responses to behavior of the computer system, e.g. indicating security incidents. A knowledge-based approach for example allows known attacks to be mitigated rapidly using prior responses that have been successful historically, without the need to repeat analysis of the attack, which can be time consuming. This allows the knowledge-based approach to perform effectively when faced with behavior that has occurred previously. However, the knowledge-based approach may be less effective when faced with new behavior or in the absence of domain knowledge pertaining to a particular type of behavior (e.g. a particular type of attack). Conversely, a prediction-based approach can generate appropriate responses to new behavior, but may perform less effectively initially (for example in the absence of a large dataset to train the ML model). However, the at least one ML model of a prediction-based approach may for example be retrained over time, to adaptively improve the responses predicted as more data is obtained. Combining these approaches in a hybrid intrusion response approach marries the strengths and mitigates the weakness of the knowledge-based and prediction-based approaches taken individually. A hybrid approach can also improve the flexibility, resilience and/or reliability of intrusion response determination, as the responses generated by each of the knowledge-based and prediction-based approaches can be used independently or in cooperation with each other. This means that an appropriate response can still be generated in the absence of a reliable response from one of the knowledge-based or the prediction-based approach. The hybrid approach of examples herein can also improve the robustness of intrusion response determination, reducing the likelihood of responding inappropriately to behavior of the computer system, which can improve the performance of the computer system.

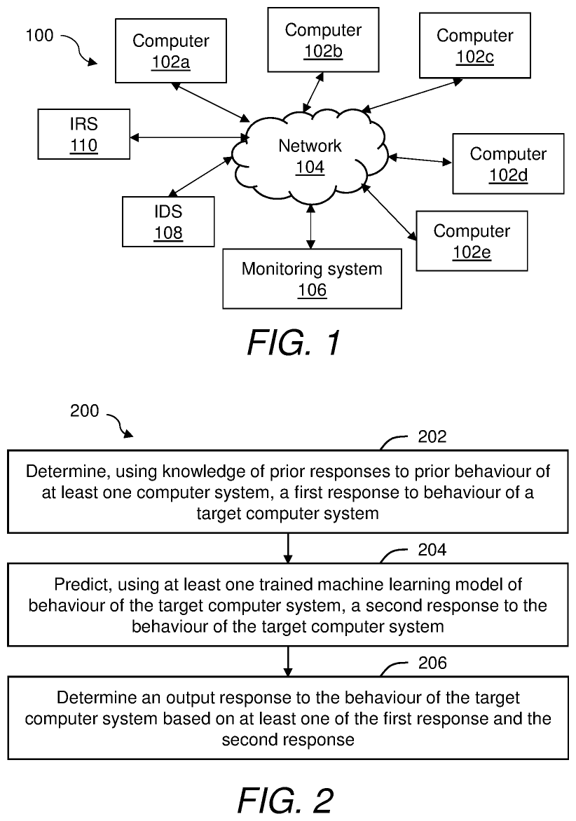

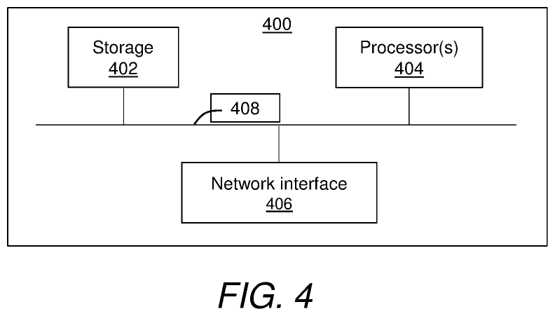

FIG. 1 is a schematic diagram showing an example system 100 for use with the examples herein, to put the examples herein into context. The system 100 includes a plurality of computers 102a-102e. Each of the computers 102a-102e may be similar to the computer 400 described further below with reference to FIG. 4, and may be a single computing device or a distributed computer. The computers 102a-102e may be considered to form a computing system.

The computers 102a-102e are each connected to a network 104 in FIG. 1. In this way, the computers 102a-102e can communicate with each via the network 104, which is for example a telecommunications network. The network 104 may be a single network or may comprise a plurality of networks. The network 104 may be or include a wide area network (WAN), a local area network (LAN) and/or the Internet, and may be a personal or enterprise network. At least one of the computers 102a-102e may be or form part of an IoT device and may therefore form part of an IoT network. An IoT device is for example a device with the means to communicate data within the environment, e.g. over a network local to the environment. Examples of IoT devices include connected refrigerators, which can provide convenient online grocery shopping functionality, smart televisions (TVs) and voice assistant devices.

The computer system (which in this case includes the computers 102a-102e) exhibits various behavior as the computers 102a-102e are used. Behavior of the computer system for example refers to activity that is performed by at least one component of the computer system, such as one of the computers 102a-102e. In the example 100 of FIG. 1, the behavior of the computer system includes network activity within the network 104. The behavior of the computer system may be represented as events that have occurred within the computer system, each corresponding to the performance of a particular task or activity. In such cases, events may correspond to log entries of log files of a monitoring system or other security system for monitoring computer behavior, e.g. sensor activations and/or network activity. Behavior of a computer system may represent at least one incident (e.g. corresponding to at least one event), which may be indicative of an attempted attack.

In the example of FIG. 1, a monitoring system 106, which is arranged to monitor network events within the network 104, generates behavior data, which in this case is representative of such events. Any suitable monitoring system 106 may be used. In one case, the monitoring system 106 includes a network tap (terminal access point), which is a device configured to analyze network traffic. A network tap typically has at least three ports: an A port, a B port and a monitor port. A tap between the A and B ports transfers data received to the desired destination, while also copying the data to the monitor port. In another case, the monitoring system 106 includes a device (such as a router or switch) configured to implement the NetFlow protocol to collect network traffic as it enters or exits the device. The network data represents or is otherwise based on the network traffic in these cases.

In the example 100 of FIG. 1, the monitoring system 106 sends the behavior data to an intrusion detection system (IDS) 108 via the network 104. The IDS 108 stores the behavior data and processes the behavior data to identify anomalous behavior of the computer system. The skilled person will appreciate that there are various techniques for intrusion detection, any of which may be utilized by the IDS 108. The IDS 108 in this case is a further computer, which may be similar to or the same as any of the computers 102a-102e connected to the network 104. In other cases, though, the monitoring system 106 need not send the behavior data to an IDS. In such cases, the monitoring system 106 may itself process the behavior data to identify the anomalies, and may itself include an IDS or be otherwise configured to perform the functionality of an IDS.

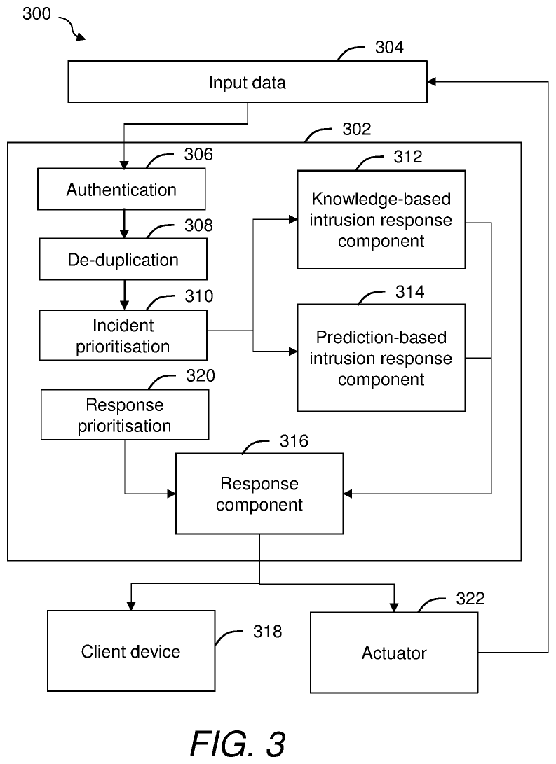

After determining that the behavior is anomalous, the IDS 108 in this example sends an indication to an intrusion response system (IRS) 110, via the network 104, that the behavior is anomalous. In response to receiving the indication, the IRS 110 then determines an output response to the behavior, for example as described further with reference to FIGS. 2 and 3. The IDS 108 may send the behavior data to the IRS 110 for processing, or the IRS 110 may receive the behavior data from a different component, such as from the monitoring system 106.

After determining the output response, the IRS 110 in this case controls the performance of mitigating action represented by the output response, to mitigate the anomalous behavior, for example by performing the mitigating action itself or by instructing at least one actuator to perform the mitigating action as discussed further with reference to FIG. 3.

FIG. 2 is a flow diagram showing an intrusion response method 200 according to examples, which may for example be performed by an IRS such as the IRS 110 of FIG. 1. Item 202 of FIG. 2 involves determining, using knowledge of prior responses to prior behavior of at least one computer system (such as the computer system discussed with reference to FIG. 1), a first response to subsequent behavior of a target computer system. The target computer system may be the same as the at least one computer system for which the prior responses are obtained. In some cases, though, the at least one computer system is or includes a different computer system than the target system. This approach can be used to expand the base of knowledge of prior responses and prior behaviors, by taking such knowledge from different computer system(s) and applying it to the target computer system for which the intrusion response method 200 is to be performed. This can be beneficial in cases in which there are few attempts to intrude on the target computer system.

Item 202 of FIG. 2 takes a knowledge-based approach to intrusion response determination, which may be referred to as a knowledge-driven approach. A knowledge-based approach for example utilizes collective wisdom from historical experiences. The efficacy of a knowledge-based approach improves as the knowledge of prior response to prior behavior increases. To deploy a knowledge-based approach, the knowledge used in such an approach is first collated, e.g. by obtaining relevant information about prior behavior and appropriate responses to that behavior. The information may then be analyzed using a set criterion or criteria based on a desired outcome (e.g. that anomalous behavior is successfully mitigated by a given response, that the response does not unduly affect operation of the computer system, and so forth). In this way, relationships between prior behavior (e.g. security incidents) and prior responses can be determined, and stored as the knowledge that is then used in future intrusion response determination using the knowledge-based approach. In some cases, cyber-security experts check the relationships to confirm that the prior responses were appropriate. In these cases, an indication of how effective a particular prior response was at mitigating a particular prior behavior can be included in the knowledge which is to be used to determine subsequent responses. A knowledge-based approach allows decision-making to be defined in advance (e.g. so that detection of a particular type of subsequent behavior of a target computer system will lead to the determination that a particular response is to be performed). This approach is for example readily understandable, and can be steered by analysts if desired.

Item 204 of FIG. 2 involves predicting, using at least one trained machine learning (ML) model of behavior of a target computer system, a second response to the behavior of the target computer system (where the behavior is for example subsequent behavior, which is performed subsequently to the behavior used to train the at least one ML model).

With the method 200 of FIG. 2, two different responses (a first response and a second response) are determined for the same behavior of the target computer system, obtained using two different approaches (a knowledge-based approach, as at item 202, and a prediction-based approach, as at item 204). The at least one ML model are mathematical models that are trained on data, e.g. of prior behavior and prior responses which were actually performed within the computer system or a different computer system, or that are computer-generated. The at least one ML model are for example trained to make predictions without being explicitly programmed to do so, for example using supervised learning, unsupervised learning or reinforcement learning techniques. A trained ML model can for example extract patterns and facts from input data and then using these facts to make inferences or other predictions, e.g. to predict the response that should be taken to the behavior of the target computer system. The field of ML is rapidly evolving, and any suitable ML technique may be used for the at least one ML model, such as deep-learning-based and federated-learning-based algorithms.

Item 206 of the method 200 of FIG. 2 involves determining an output response to the behavior of the target computer system based on at least one of the first response (determined at item 202) and the second response (determined at item 204). This may for example involve taking either the first response or the second as the output response, determining that the output response is to include both the first and second responses or determining the output response as a combination of at least part of the first and second responses, as explained further with reference to FIG. 3.

FIG. 3 is a schematic diagram of a system 300 including an IRS 302 according to examples. The IRS 302 receives input data 304, e.g. from an IDS or a monitoring system as discussed with reference to FIG. 1. The input data 304 includes behavior data indicative of behavior of a target computer system. In this example, the IRS 302 is configured to receive behavior data from various environments, e.g. representing network intrusion, IoT device intrusion, and so forth. As the IRS 302 can receive behavior data from different sources, the IRS 302 can for example learn from responses performed in one context to identify appropriate responses to behavior in a different context, as discussed further below. For example, the behavior data may include data obtained from a Network Address Translation (NAT) router, data obtained from a Security Information and Event Management (SIEM) system, data obtained from a Privileged Access Management (PAM) system, and/or a User and Event Behavioral Analytics (UEBA) system. The behavior data may represent an alert from a monitoring system (e.g. in the form of a log entry or a log file). The input data 304 may include an indication from an IDS that the subsequent behavior (e.g. corresponding to a particular event or events that have occurred within the target computer system) is anomalous.

The input data 304 may include further contextual information such as alert data indicative of at least one further alert that has been raised within the target computer system, traffic data indicative of network traffic of a network to which the target computer system is connected, domain knowledge indicative of a domain of the target computer system, device detail indicative of characteristic(s) of at least one computer of the target computer system, environmental detail indicative of characteristic(s) of an environment of the target computer system, user information indicative of a user of at least one computer of the target computer system, and so forth. The contextual information may be provided by various sources such as domain experts, administrative systems (e.g. associated with a network or environment), data and/or log providers, and so forth.

The input data 304 is received by an authentication component 306 of the IRS 302. The authentication component 306 is configured to authenticate that the behavior of the target computer system is anomalous. In other words, the authentication component 306 can confirm that a previous indication of the behavior of the target computer system as anomalous, e.g. by an IDS, is a true positive. Various techniques can be used by the authentication component 306, such as signature-based, statistical anomaly-based, rule-based, policy-based or stateful protocol analysis-based methods. In the IRS 302 of FIG. 3, the authentication component 306 is configured to use a stateful protocol analysis to compare the observed behavior of the target computer system (e.g. as represented by the behavior data of the input data 304) with pre-determined profiles of generally accepted definitions of benign activity, to ascertain whether the behavior is indeed anomalous or whether it has been misclassified as anomalous.

If the behavior of the target computer system is identified as a false positive (in other words, if the behavior is not actually anomalous), processing of the behavior data by the IRS 302 ceases. If, however, the authentication component 306 confirms that the behavior of the target computer system is indeed anomalous, processing of the behavior data by the IRS 302 continues. This improves the efficiency of the IRS 302, by focusing resources on behavior that is truly anomalous.

As explained above, the input data 304 may include behavior data received from a plurality of different sources. For example, the behavior data may include first incident data from a first source (e.g. an IDS), and second incident data from a second source (e.g. a UEBA). However, more than one source (e.g. more than one monitoring system) may generate a respective alert for the same incident or other event. To mitigate this, the example IRS 302 includes an incident de-duplication component 308 of the IRS 302, which is configured to perform incident de-duplication after authentication has been performed by the authentication component 306. In this example, the incident de-duplication component 308 can determine whether the second incident data from the second source includes a portion representative of an incident within the target computer system, which is the same incident as that represented by a portion of the first incident data from the first source. If this is the case, the incident de-duplication component 308 then processes the second incident data to remove the portion of the second incident data which is a duplicate, to generate updated second incident data. Behavior data representative of the behavior of the target computer system can then be generated, e.g. for further processing by other components of the IRS 302, using the first incident data and the updated second incident data, i.e. with the duplicate of the incident removed. Using the incident de-duplication component 308 in this way helps to reduce the number of incidents for which a response is to be generated using the IRS 302. This increases the efficiency of the IRS 302 by reducing repeated processing of the same incident. For example, rather than creating, as part of the behavior data output by the incident de-duplication component 308, a new incident based on the portion of the second incident data, a count value of the incident (e.g. as based on the portion of the first incident data) can instead be increased. As an example, if the portion of the first incident data is associated with a particular characteristic (e.g. a particular Internet Protocol (IP) address), the incident de-duplication component 308 can identify whether a portion of the second incident data is also associated with the same characteristic (e.g. the same IP address). If so, information derived from the portion of the second incident data can be added to a current incident based on the portion of the first incident data, rather than creating a new incident. The behavior data output by the incident de-duplication component 308 for example includes data representative of the current incident, and may include data representative of at least one further incident identified by the first and/or second source. The behavior data may be stored in suitable storage accessible to the IRS 302, such as a database, from where it may be retrieved for further processing. Such a database for example stores an organized collection of data related to behavior of the target computer system (and, in some cases, behavior of other computer system(s)). The database can for example store information output by the incident de-duplication component 308, as well as at least some of the input data 304, such as the incident information, contextual information and/or the impact score.

After incident de-duplication has been performed, the behavior data representative of the behavior of the target computer system is obtained by an incident prioritization component 310, either from the incident de-duplication component 308 or from storage. The incident prioritization component 310 is used to prioritize incidents e.g. according to how severe respective incidents are. For example, the incident prioritization component 310 may assign behavior data representative of an incident (e.g. corresponding to the behavior of the target computer system) an incident priority level signifying the urgency of responding to that particular incident, so that incidents that are likely to have the greatest negative impact on the target computer system can be prioritized over less critical incidents. The incident prioritization component 310 receives behavior data representative of the behavior of the target computer system as well as further behavior data representative of further behavior of the target computer system. The incident prioritization component 310 then ranks the behavior (e.g. representing respective incidents) in order of severity. Various different ranking techniques may be used. For example, a simple list-based approach can be used in which critical assets (such as devices and/or components of the target computer system that are critical to normal functioning of the target computer system) are recorded in a list. If any incident affects the performance or usage of a critical asset, the incident can be prioritized. Alternatively, various formulas may be used to prioritize incidents, e.g. based on the number of devices involved, how critical the device(s) affected are to functioning of the computer system and/or device traffic.

After an incident prioritization level is assigned to the behavior data (which in this case is representative of the behavior of the target computer system), the behavior data is obtained by a knowledge-based intrusion response (IR) component 312 and by a prediction-based IR component 314.

The knowledge-based IR component 312 is configured to use knowledge of prior responses to prior behavior of at least one computer system to determine a first response to the behavior of the target computer system. The prior behavior may include prior anomalous behavior of the at least one computer system, such that the knowledge indicates prior responses that were taken to mitigate the prior anomalous behavior. In some case, though, the prior behavior additionally or alternatively includes prior benign behavior of the at least one computer system, such that the knowledge indicates prior responses that were taken in response to the prior benign behavior, to provide more information regarding historical responses that were performed in response to varying types of behavior.

The knowledge-based IR component 312 may include a knowledge storage component, which includes data indicative of information, heuristics and guidance regarding specific environments, relevant incidents and related facts on these incidents. Knowledge stored by the knowledge storage component may have been collected from textbooks, guidelines and prior incidents, which may be referred to as domain knowledge. Knowledge stored by the knowledge storage component may also or instead have been acquired from interviews, scientific papers, opinions and the experiences of experts, engineers and researchers, which may be referred to as a priori and a posteriori knowledge. This knowledge could exist in various different formats, such as text, formulas, tables or diagrams.

The knowledge-based IR component 312 may additionally include a knowledge engineering component. The knowledge engineering component is for example configured to acquire knowledge from the knowledge storage component, such as concepts and relationships between concepts (which may be referred to as a conceptualization). The knowledge engineering component for example includes computational models, such as knowledge structures, instances and inference rules, and generates engineered knowledge based on the knowledge acquired from the knowledge storage component.

The knowledge-based IR component 312 may additionally include a knowledge base (KB) to store the engineered knowledge obtained from the knowledge engineering component. The KB includes a plurality of instances, each representative of a specific case of a particular type of knowledge, such as a particular “thing” (e.g. a particular device, action, response etc.) represented by a concept (which for example corresponds to a set or class of entities within a domain, such as a device type, action type, response type etc.). For example, a botnet attack is a type of network attack. Three specific botnet attacks may be considered to be three instances of the botnet attack type, each for example corresponding to a particular instance (sometimes referred to as an entity) of the KB.

In some cases, at least part of the knowledge of the prior responses to prior behavior is stored in the KB. In one such case, the KB includes a first plurality of instances, each corresponding to a respective prior response performed in at least one computer system (which may or may not include the target computer system) in response to prior behavior. In this case, the KB also includes a second plurality of instances, each corresponding to a respective prior behavior of the at least one computer system. The prior responses may correspond to responses that were performed in response to the prior behavior, although there need not be a one-to-one mapping between the first and second plurality of instances. For example, the same prior response may have been taken in response to different prior behavior, or the same prior behavior may have led to different prior responses (e.g. with different degrees of success in mitigating the prior behavior).

The KB may be associated with a domain theory, which refers to various concepts, relationships, logical operators and/or mathematical operators for constructing complex concepts from primitive ones, as well as corresponding models for interpreting knowledge represented by expressions and/or formulas.

In some examples, the knowledge-based IR component 312 is configured to use rules derived from the knowledge, each indicative of an appropriate response to particular behavior of a computer system, to determine the first response. An appropriate response is for example a response that adequately mitigates a security threat to the target computer system (e.g. to counteract a threat posed by the behavior of the target computer system), without unduly affecting performance of the target computer system, or with reduced impact on the performance of the target computer system than if the threat were allowed to proceed without intervention. The rules, which may be considered to represent a data to action correlation model, for example specify a causal relationship between behavior and responses based on the knowledge, for example as stored in the KB, e.g. of the prior responses and prior behavior. For example, the knowledge that a prior botnet attack led to closure of a local network of the target computer system in response can be reframed as a rule to respond by closing the local network if the behavior of the target computer system indicates that the same attack as the prior botnet attack is underway. More complex correlation rules can in some cases be constructed using logical connectors and mathematical operators to express responses that are to be taken to respond to various behavior scenarios. As the skilled person will appreciate, various pre-processing techniques may be applied to the knowledge obtained by the knowledge-based IR component 312 to prepare the knowledge for ingestion by the KB and/or for processing to determine the rules.

The rules and the behavior of the target computer system (for example in the form of at least one instance corresponding to an instance of the KB) are for example processed by a knowledge-driven reasoning component of the knowledge-based IR component 312. The knowledge-driven reasoning component is for example configured to perform causal reasoning, which is a decision-making process to derive the first response to the behavior of the target computer system. The knowledge-driven reasoning component for example determines the first response based on the at least one instance corresponding to the behavior of the target computer system and the rules. In some cases, the mapping of the behavior of the target computer system to particular instance(s) of the KB is performed by knowledge-driven reasoning component, although this need not be the case in other examples.

The behavior data output by the incident prioritization component 310 is also processed by a prediction-based IR component 314 in the IRS 302 of FIG. 3. The prediction-based IR component 314 is configured to use at least one trained machine learning (ML) model of behavior of the target computer system to predict a second response to the behavior of the target computer system. Although the at least one ML model is of behavior of the target computer system, it is to be appreciated that the at least one ML model may have been trained using data representative of behavior and/or actions of the target computer system and/or at least one further computer system, which nevertheless is considered to have some similarities with the target computer system (such as being sensitive to similar security threats).

In examples such as that of FIG. 3, the prediction-based IR component 314 is configured to process behavior data representative of the behavior of the target computer system using the at least one trained ML model, without interacting with the knowledge-based IR component 312, to predict the second response. The knowledge-based IR component 312 and the prediction-based IR component 314 in such examples can therefore predict the first and second responses independently each of other, providing more flexibility. Decoupling the knowledge-based IR component 312 and the prediction-based IR component 314 in this way for example facilitates parallel processing of the behavior data by the knowledge-based IR component 312 and the prediction-based IR component 314, which can improve the efficiency of the intrusion response determination. However, the at least one ML model of the prediction-based IR component 314 may previously have been trained using at least part of the knowledge of the prior response to the prior behavior of the at least one computer system, to exploit the knowledge of the knowledge-based IR component 312. In other cases, though, the at least one ML model may be trained using different training data, e.g. that does not form part of the knowledge of the knowledge-based IR component 312, so that the knowledge-based IR component 312 and the prediction-based IR component 314 remain independent.

Before processing the behavior data using the at least one trained ML model, the behavior data may undergo feature engineering, in which the behavior data is transformed into a format that facilitates easier processing by the at least one trained ML model. For example, feature selection, feature extraction and/or dimensionality reduction may be applied to the behavior data to extract features from the behavior data (which may be in the form of raw data, e.g. as received from a particular source such as a monitoring system). A feature is for example an attribute or property of the behavior of the target computer system. The feature engineering may be based at least partly on data received from the incident prioritization component 310 and/or the knowledge storage component of the knowledge-based IR component 312.

The behavior data is processed using the at least one trained ML model to predict the second response. In some examples, the prediction-based IR component 314 includes a plurality of ML models, and the prediction-based IR component 314 is configured to predict respective responses to the behavior of the target computer system using each of the plurality of ML models and select one of the respective responses to use as the second response. In such cases, the behavior data may be processed in parallel, e.g. independently, using the plurality of ML models, to improve efficiency.

The response selected as the second response may be selected on the basis of various criteria. For example, the responses predicted by each of the ML models can be compared to historical actions to determine the likelihood of successfully addressing the behavior of the target computer system (e.g. to mitigate a threat) and/or based on at least one metric. In one case, the response is selected on a precision of the response. For example, a first model (corresponding to a decision tree), a second model (corresponding to a k-mean clustering algorithm) and a third model (corresponding to a random forest) may each be used to process the behavior data and predict respective responses to the behavior of the target computer system (as represented by the behavior data). If the precision of the first model is 95%, the precision of the second model is 98% and the precision of the third model is 97%, the second model will be selected to predict the second response, and the output of the second model will be taken as the second response.

The IRS 302 of FIG. 3 also includes a response component 316 configured to determine an output response to the behavior of the target computer system based on at least one of the first response obtained by the knowledge-based IR component 312 and the second response obtained by the prediction-based IR component 314. In other words, the output response may be based on either the first response or the second response or a combination of both the first and second responses.

In some cases, such as that of FIG. 3, the response component 316 is configured to determine which of the first and/or second response to use to determine the output response based on a similarity between the behavior of the target computer system and the prior behavior of the at least one computer system. For example, if the behavior of the target computer system has a similarity to the prior behavior of the at least one computer system that satisfies a similarity condition (such as meeting or exceeding a similarity threshold, such as 90%), the behavior of the target computer system may be classified as known behavior. For example, at least one feature of the behavior and the prior behavior may be compared to obtain a similarity score, indicative of the similarity between the behavior and the prior behavior.

In one illustrative example, the behavior has the features: (src_ip: 0.0.0.0, dst_ip: 0.0.0.1, port: 8000, size: 10) and the target behavior has the features: (src_ip: 0.0.0.0, dst_ip: 0.0.0.2; port: 8000, size: 12), where src_ip indicates the source IP address of a packet, dst_ip indicates the destination IP address of the packet, port indicates the destination port of the packet, and size indicates the size of the packet in bytes. In this example, a distance measure can be computed, and used to indicate the similarity (where a smaller distance measure implies greater similarity). In this case, if the src_ip address of the behavior and the target behavior are the same, a score of 0 is allocated for a src_ip component. Otherwise, a score of 1 is allocated for the src_ip component. Similarly, if the dst_ip address of the behavior and the target behavior are the same, a score of 0 is allocated for a dst_ip component. Otherwise, a score of 1 is allocated for the dst_ip component. If the ports of the behavior and the target behavior are the same, a score of 0 is allocated for a port component. Otherwise, a score of 1 is allocated for the port component. The absolute distance between the packet size of the behavior and the target behavior is taken as a packet size component. The src_ip component, the dst_ip component, the port component and the packet size component are combined (in this case, by addition), to obtain a distance measure of: 0+1+0+2=3. For another target behavior with the features of (src_ip: 0.0.0.3, dst_ip: 0.0.0.4; port: 9000, size: 12), the distance measure with respect to the behavior is: 1+1+1+2=5, indicating that the other target behavior is less similar than the target behavior with the features: (src_ip: 0.0.0.0, dst_ip: 0.0.0.2; port: 8000, size: 12). It is to be appreciated that this is merely an example to illustrate the principles behind determination of the similarity between the behavior and the prior behavior. In other cases, a different function may be used to compute a distance measure (or other metric), which may weight different features by different amounts. Furthermore, other features may be used instead of or in addition to the features discussed above for the determination of the similarity. For example, the alert type (e.g. indicating whether the behavior is indicative of a distributed denial-of-service (DDoS) attack, whether the behavior is indicative of a malware attack, whether the behavior is indicative of a ransomware attack, etc.) may be used as a feature for determining the similarity between the behavior and the target behavior. The alert type may be weighted to contribute to a distance measure or other metric indicative of the similarity to a greater extent than other feature(s), as the alert type is likely to be a greater indicator of the similarity between the behavior and the target behavior than other features. The alert type may for example be obtained from an IDS.

If the behavior of the target computer system is relatively dissimilar to prior behavior, the behavior of the target computer system may be classified as unknown behavior, e.g. which has not occurred or which has not been detected previously. Known behavior can be responded to using the first response (obtained using the knowledge-based IR component 312) as the output response, without using the second response. However, if the behavior of the target computer system is classified as unknown behavior, the second response, obtained by the prediction-based IR component 314, can be used as the output response without using the first response, as the prediction-based IR component 314 is likely to predict a more appropriate response in unknown scenarios than the knowledge-based IR component 312. In certain situations, though, the second response may not be the most appropriate response to unknown behavior, e.g. if the unknown behavior is very different from behavior the at least one ML model has been trained using and/or if the at least one ML model has been trained using a relatively limited amount of data.

To reduce the risk of selecting an inappropriate response to behavior of the target computer system, the response component 316 is, in some cases, configured to determine which of the first and/or second response to use to determine the output response based on a forecast effect on the target computer system of performance of at least one of the first response or the second response. In such cases, the forecast effect may be used alone or in conjunction with at least one other consideration, such as the similarity between the behavior of the target computer system and the prior behavior of the at least one computer system, to determine which of the first and/or second response to use to determine the output response. The forecast effect may be based on a prior effect on the at least one computer system of the at least one of the first response or the second response. For example, the prior effect may be taken as the forecast effect, if it is assumed that the outcome of performing the first or second response previously within the at least one computer system will be the same as (or similar to) the outcome of performing the first or second response within the target computer system. The forecast effect (which may be based on the prior effect) may indicate a forecast success rate (which may be based on a prior success rate) of preforming the first or second response. For example, if the behavior of the target computer system indicates an unknown malware incident, the knowledge-based IR component 312 may output a suggestion to “run an anti-malware scan” as the first response, based on previous similar incidents, whereas the prediction-based IR component 314 may instead output a suggestion to “reboot the target computer system”. The response component 316 can then ascertain the forecast effect of both the first and second responses, e.g. by determining the prior success rate of the first and second responses. If the prior success rate of the first response is higher, then the first response is selected as the output response. Conversely, if the prior success rate of the second response is higher, the second response is selected as the output response. If the prior success rate is the same for both the first and second response, the response component 316 may use one of the first or second response as a default output response. In some cases, the first response is taken as the default output response, since the first response is based on historical knowledge, which may in some cases be expert-curated, which may be more reliable.

The response component 316 may additionally or alternatively send data indicative of the first and/or second response to a client device 318 for a human analyst to determine which of the first and/or second response to perform. The analyst may make this determination and send a response from the client device 318 indicating the determination. Upon receiving the response from the client device 318, the response component 316 can then generate the output response.

In some cases, the response component 316 may determine the output response based on both the first and second response. For example, the output response may include both the first and second response, concurrently or in parallel, to further improve security. This may be performed if the first and second responses are relatively computationally inexpensive to deploy and/or if the success rate of each of the first and second responses individually is relatively low.

Determining the output response to deploy may include response arbitration and/or reconciliation to analyze the output response proposed by the response component 316. For example, response verification may be perform to verify that the output response is appropriate for the behavior of the target computer system. Verification may involve the IRS 302 sending an alert to the client device 318, e.g. via a network such as the network 104 of FIG. 1. The client device 318 in this case is a computing device, such as a desktop computer, laptop computer or mobile phone (e.g. a smartphone). The alert indicates to the client device 318 the proposed response that is being taken or is about to be taken by the IRS 302 in response to the behavior of the target computer system. The alert may be in any suitable format, e.g. an electronic message (such as an email or text message) or a notification in an application associated with the IRS 302. If the alert is sent before the output response is performed, a user of the client device 318 can verify that the output response is appropriate and send a suitable reply to the alert. If, however, the user of the client device 318 considers that the output response is inappropriate, a reply indicating this can be sent to the IRS 302, and the response component 316 can determine an alternative output response to the behavior of the target computer system. In other cases, though, verification may be performed by an automated system rather than involving a human in the loop.

Impact analysis may also or instead be performed, which for example involves determining the forecast effect of performing the output response on the target computer system. Impact analysis may involve assigning a score, such as a numerical value, to the output response, indicating the forecast effect of performing the output response. For example, the forecast effect of blocking a domain may be relatively low, whereas the forecast effect of rebooting a server may be relatively high. The forecast effects may be determined using various approaches, such as using expert knowledge, simulations (e.g. using machine learning), or historical impact scores of responses based on the prior effect previous responses had on at least one computer system.

The IRS 302 of FIG. 3 includes a response prioritization component 320 which is configured to prioritize the deployment of responses, using the IRS 302, to respective behavior of the target computer system, based on a forecast effect of the respective behavior on the target computer system. For example, if particular behavior is forecast to have a severe effect on the target computer system (e.g. if the particular behavior indicates a security breach of a critical system), deployment of the output response to the particular behavior can be prioritized with respect to output responses to other behavior that is of lower impact (e.g. that affects a lower-priority component of the target computer system). Although not shown in FIG. 3, it is to be appreciated that the response prioritization component 320 may also be arranged to obtain user input on prioritization of responses, e.g. by sending a message to the client device 318 or a different client device. Prioritization data indicative of the prioritization of responses as determined by the response prioritization component 320 of FIG. 3 are sent to the response component 316, which can then determine the order in which to deploy output responses to respective behavior of the target computer system, determined based on first and/or second responses from the knowledge-based IR system 312 and the prediction-based IR system 314 respectively.

After determining that a particular output response is to be deployed, the IRS 302 in the example of FIG. 3 is configured to instruct at least one actuator 322 to perform the output response. The output response for example represents a mitigating action to mitigate anomalous behavior of the target computer system. The at least one actuator 322 is a device that enables interaction with the physical components of the target computer system, for example to automatically deploy the output response without requiring human intervention. This for example allows the output response to be deployed more efficiently than otherwise. In other cases, though, the IRS 302 itself is configured to perform the output response, e.g. representing a mitigating action. For example, the IRS 302 may itself include at least one actuator or may be otherwise suitable configured to perform the output response.

Performance of the output response, such as the effect of the output response on the behavior of the target computer system, can be used to update at least one component of the IRS 302 to improve the determination of output responses to future behavior of the target computer system or another computer system. In the example of FIG. 3, the actions performed by the at least one actuator 322 cause new input data 304 to be generated, e.g. representative of new incident information and/or contextual information. The new input data 304 may indicate an effect of the output response on the target computer system, or may be useable by the IRS 302 to determine the effect of the output response on the target computer system. For example, the new input data 304 may include an impact score that indicates the effectiveness of the output response performed by the at least one actuator 322 in mitigating the behavior of the target computer system. The impact score can be calculated based on various factors, e.g. defined by domain experts. In this case, the knowledge useable by the knowledge-based IR system 312, e.g. as stored in a KB, can be updated based on the behavior of the target computer system and the output response, e.g. based on the effect of the output response on the target computer system (as represented by the impact score, for example). This can improve future performance of the IRS 302, by allowing output responses that improve or reduce performance of the target computer system to be identified. For example, the rules indicative of appropriate responses to behavior can be updated, e.g. to add a new rule where the output response is a new response that the impact score indicates is successful in addressing the behavior of the target computer system, or to remove an existing rule corresponding to the output response, where the impact score indicates that the output response had a negative impact on performance of the target computer system.

The prediction-based IR system 314 may also or instead be updated based on the output response on the behavior of the target computer system. For example, at least one of the ML models of the prediction-based IR system 314 may be retrained based on the behavior of the target computer system and the output response, e.g. based on the effect of the output response on the behavior of the target computer system. The IRS 302 may include a model training component to train and/or retrain the at least one ML model. By retraining the at least one of the ML models, performance of the prediction-based IR system 314 can be incrementally improved, to select more appropriate responses to behavior of a computer system. In such cases, training data used by the model training component to train at least one of the ML models may be obtained after feature engineering, and may additionally obtain knowledge obtained from the knowledge storage component of the knowledge-based IR system 312.

FIG. 5 is a schematic diagram of internal components of a system that may be used in the implementation of any of the methods described herein, which in this example is a computer system 400. For example, the computer system 400 may be used as any of the computers 102a-102e, the monitoring system 106, the IDS 108 or the IRS 110 of FIG. 1. The computer system 400 in FIG. 4 is implemented as a single computer device but in other cases a similar computer system may be implemented as a distributed system.

The computer system 400 includes storage 402 which may be or include volatile or non-volatile memory, read-only memory (ROM), or random access memory (RAM). The storage 402 may additionally or alternatively include a storage device, which may be removable from or integrated within the computer system 400. The storage 402 may be referred to as memory, which is to be understood to refer to a single memory or multiple memories operably connected to one another. The storage 402 may be or include a non-transitory computer-readable medium. A non-transitory computer-readable storage medium includes, but is not limited to, volatile memory, non-volatile memory, magnetic and optical storage devices such as disk drives, magnetic tape, compact discs (CDs), digital versatile discs (DVDs), or other media that are capable of storing code and/or data.

The computer system 400 also includes at least one processor 404 which is configured to perform processing, e.g. implement any of the methods described herein (where the computer system 400 is used as an IRS such as the IRS 302 of FIG. 3). The at least one processor 404 may be or comprise processor circuitry. The at least one processor 404 is arranged to execute program instructions and process data, such as the network data. The at least one processor 404 is for example arranged to process instructions, obtained from the storage 402, to implement any of the methods described herein. The at least one processor 404 may include a plurality of processing units operably connected to one another, including but not limited to a central processing unit (CPU) and/or a graphics processing unit (GPU).

The computer system 400 further includes a network interface 406 for connecting to a network, such as the network 104 of FIG. 1. A computer system otherwise similar to the computer system 400 of FIG. 4 may additionally include at least one further interface for connecting to at least one further component, such as a display interface for connecting to a display device (which may be separable from or integral with the computer system). The components of the computer system 400 are communicably coupled via a suitable bus 408.

### Example

An example to illustrate the concepts described herein will now be described. In this illustrative example, which may implemented using the example system 300 of FIG. 3, a ransomware attack of a target computer system is detected by an endpoint detection tool and an alert is created. The alert is placed into the incident queue (e.g. by sending input data 304 corresponding to the alert to an IRS 302), and is prioritized at the top of the queue as it involves a critical system. The identification of the alert as relating to a critical system is determined, e.g. using an incident prioritization component 310, based on the alert, as the hostname contained within the alert is on a list of critical hostnames. The alert includes some supplementary data, such as the threat type, the time at which the event was generated, the hostname, a description of the event, and so forth.

Relevant features of the alert are extracted and sent to a knowledge-based IR component 312 and a prediction-based IR component 314. The knowledge-based IR component 312 and the prediction-based IR component 314 generate a first response and a second response, respectively, which are sent to a response component 316. The response component 316 takes into account the history of the first and second responses, experience of the knowledge-based IR component 312 and the prediction-based IR component 314 against the current threat, and the forecast effect of each of the responses on the target computer system, and makes a decision of which response to perform. In this example, the prediction-based IR component 314 has not encountered a threat of this kind before, so the response component 316 determines that the first response generated by the knowledge-based IR component 312 is to be taken as the output response.

In this case, the output response involves removing a device from the target computer system that has suffered the ransomware attack. The impact score of performing this output response is calculated. In this example, a few other devices are affected by removing the attacked device. However, it is determined to be riskier not to remove the attacked device.

In this case, the alert is updated with the actions taken as part of the output response, and any extra supplementary data generated by performing the output response. The alert is now considered less severe and is deprioritized since the output response performed has helped to reduce the threat posed, which is indicated by a reduced severity score indicated by the alert.

Further alerts that are of higher priority can then be addressed in a similar manner by the IRS 302. Once the more severe alerts have been addressed, this alert can then be analyzed again, to determine whether any additional actions are to taken to further mitigate the risk posed by the behavior of the target computer system. A similar process can then be performed again. It is hence to be appreciated that the IR methods described herein may be performed iteratively, as performing an output response determined by the response component 316 will typically affect subsequent behavior of the target computer system. For example, after removal of a device from a target computer system, fewer alerts may be generated (or alerts of a different type may be generated, e.g. corresponding to other threats). In another case, after an email address has been blocked, fewer or no phishing alerts may be generated. After particular behavior has been addressed, additional information may be generated, indicative of an updated state of the target computer system (e.g. corresponding to updated behavior of the target computer system), caused by performance of the output response. For example, updating the state of the target computer system may involve deprioritizing an alert (as in the present example) and/or updating the behavior of the target computer system to include behavior subsequent to the performance of the output response (such as at least one further alert). In such cases, the behavior of the target computer system for which the output response is to be generated at a particular iteration may hence include behavior subsequent to the performance of mitigating action for a previous iteration. The behavior of the target computer system for a particular iteration may also include the behavior that caused the mitigating action to be performed, to give greater information to the IRS 302.

Returning to the present example of a ransomware attack, in this example, the response component 316 determines that, after removing the device from the target computer system and addressing the more severe alerts, the next few responses to be taken are to be those determined by the knowledge-based IR component 312, since the behavior of the target computer system corresponds to previously-experienced attack. The next few responses to be performed are to first collect information from the device owner to enrich the alert and create more features that can e.g. be analyzed further by the IRS 302, then to shut down the device, followed by rebuilding the device.

After these actions are performed, the response component 316 determines that the next response is to be taken from the prediction-based IR component 314, which determines that the next response to perform is to block the creation of all file types of the kind detected. It is determined that this response has a low impact score and will help to further contain the threat. This response is performed and the impact score is determined, indicating the effect of this response on the target computer system. In this case, the impact score is low as the creation of this particular file type is usually very rare. The impact score in this case also indicates that the current creation of these file types has temporarily halted, which means that the response performed has successfully helped to contain the threat. This feedback is used to retrain at least one of the ML models of the prediction-based IR component 314.

The response component 316 determines that the next few responses are to be those obtained from the knowledge-based IR component 312. The next few responses include blocking the email address associated with the alert (which is provided from the information collected from the user) and escalating the threat to a human analyst. The human analyst determines that the device needs patching and installs the latest updates. This action is captured and stored in the knowledge repository along with the impact score for the action. The alert is then closed as the device is back online and is not exhibiting any behavior related to the ransomware.

### Further Alternatives and Modifications

In the example of FIG. 1, the behavior of the computer system includes network activity within the network 104. However, in other cases, the behavior of a target computer system which is to undergo intrusion response detection may be or include different types of behavior than network activity. For example, where the target computer system includes at least one sensor, behavior of the target computer system may include a sensor activation of the sensor.

In the example of FIG. 1, the computer system includes a plurality of computers 102a-102e. However, in other examples, the computer system may include a single computer (which may distributed or otherwise).

Although the method 200 of FIG. 2 shows the first response being obtained and then the second response being obtained, it is to be appreciated that in other examples the second response may be obtained before the first response or the first and second responses may be obtained in parallel or at least partly in parallel.

In FIG. 3, the IRS 302 is shown as including an authentication component 306, a de-duplication component 308, an incident prioritization component 310 and a response prioritization component 320. However, other IRSs that are otherwise similar to the IRS 302 of FIG. 3 need not have at least one of these components, and in some cases have none of these components.

The above-described example of the ransomware attack describes an iterative approach to addressing a particular incident, in which a series of actions are taken to address a single incident, with additional information generated at each iteration to reflect the updated state of the target computer system. However, it is to be appreciated that, in other examples, an iterative approach such as this may not be used, e.g. if particular behavior can be addressed with a single action (as represented by a single output response).

A single output response may, in some cases, indicate that a plurality of actions are to be performed. This may be more efficient than iteratively determining a plurality of output responses, which may be appropriate in addressing behavior that poses a high security risk to the target computer system but which requires a number of steps to be taken to adequately address. For example, a prior response may represent a plurality of actions that were taken to address a particular threat and/or the at least one ML model may be trained to predict responses, at least one of which represents a plurality of actions.

Each feature disclosed herein, and (where appropriate) as part of the claims and drawings may be provided independently or in any appropriate combination.

Any reference numerals appearing in the claims are for illustration only and shall not limit the scope of the claims.

In general, it is noted herein that while the above describes examples, there are several variations and modifications which may be made to the described examples without departing from the scope of the appended claims. One skilled in the art will recognize modifications to the described examples.

1. An intrusion response system (IRS) comprising:
a knowledge-based intrusion response (IR) component configured to use knowledge of prior responses to prior behavior of at least one computer system to determine a first response to behavior of a target computer system;
a prediction-based IR component configured to use at least one trained machine learning (ML) model of behavior of the target computer system to predict a second response to the behavior of the target computer system; and
a response component configured to determine an output response to the behavior of the target computer system based on at least one of the first response or the second response.

2. The IRS according to claim 1, wherein the prediction-based IR component is configured to process behavior data representative of the behavior of the target computer system using the at least one trained ML model, without interacting with the knowledge-based IR component, to predict the second response.

3. The IRS according to claim 1, wherein the prior behavior of the at least one computer system comprises prior anomalous behavior of the at least one computer system.

4. The IRS according to claim 1, wherein the knowledge-based IR component is configured to use rules derived from the knowledge, each rule indicative of an appropriate response to particular behavior of a computer system, to determine the first response.

5. The IRS according to claim 4, wherein at least part of the knowledge used by the knowledge-based IR component is stored in a knowledge base comprising a plurality of instances, each instance corresponding to a respective one of the prior behaviors, and the knowledge-based IR component is configured to:
identify at least one instance of the plurality of instances corresponding to the behavior of the target computer system; and
determine the first response based on the at least one instance and the rules.

6. The IRS according to claim 1, wherein the prediction-based IR component comprises a plurality of ML models of behavior of the target computer system, and the prediction-based IR component is configured to:
predict respective responses to the behavior of the target computer system using each of the plurality of ML models; and
select one of the respective responses to use as the second response.

7. The IRS according to claim 1, wherein the response component is configured to determine which of the first response or the second response to use to determine the output response based on a similarity between the behavior of the target computer system and the prior behavior of the at least one computer system.

8. The IRS according to claim 7, wherein the response component is configured to determine the output response based on the first response without using the second response in response to determining that the behavior of the target computer system corresponds to the prior behavior of the at least one computer system.

9. The IRS according to claim 1, wherein the response component is configured to determine which of the first response or the second response to use to determine the output response based on a forecast effect on the target computer system of performance of at least one of the first response or the second response.

10. The IRS according to claim 9, wherein the forecast effect of performance of the at least one of the first response or the second response is based on a prior effect on the at least one computer system of prior performance of the at least one of the first response or the second response.

11. The IRS according to claim 1, comprising an incident de-duplication component configured to:
receive first incident data from a first source, the first incident data comprising a portion representative of an incident within the target computer system;
receive second incident data from a second source;
determine that the second incident data comprises a portion representative of the same incident as the first incident data;
process the second incident data to remove the portion of the second incident data, thereby generating updated second incident data; and
generate behavior data representative of the behavior of the target computer system using the first incident data and the updated second incident data.

12. The IRS according to claim 1, wherein the behavior of the target computer system has been identified as anomalous by an intrusion detection system (IDS).

13. The IRS according to claim 1, comprising an authentication component configured to authenticate that the behavior of the target computer system is anomalous.

14. The IRS according to claim 1, comprising a response prioritization component configured to prioritize deployment of responses, using the IRS, to respective behavior of the target computer system, based on a forecast effect of the respective behavior on the target computer system.

15. The IRS according to claim 1, further configured to update the knowledge useable by the knowledge-based IR system based on an effect of the output response on the target computer system.

16. The IRS according to claim 1, wherein the behavior of the target computer system comprises anomalous behavior of the target computer system and the IRS is configured to perform a mitigating action represented by the output response to mitigate the anomalous behavior.

17. The IRS according to claim 1, wherein the behavior of the target computer system comprises anomalous behavior of the target computer system and the IRS is configured to instruct at least one actuator to perform a mitigating action represented by the output response to mitigate the anomalous behavior.

18. A telecommunications network comprising the IRS according to claim 1.

19. An intrusion response method comprising:
determining, using knowledge of prior responses to prior behavior of at least one computer system, a first response to behavior of a target computer system;
predicting, using at least one trained machine learning (ML) model of behavior of the target computer system, a second response to the behavior of the target computer system; and
determining an output response to the behavior of the target computer system based on at least one of the first response or the second response.

20. The intrusion response method of claim 19, further comprising:
receiving, from an intrusion detection system, an indication that the behavior of the target computer system is anomalous; and
in response to receiving the indication, performing the determining the first response, the predicting the second response and the determining the output response.

21. The intrusion response method of claim 19, further comprising training at least one of the ML models based on at least part of the knowledge of the prior responses to the prior behavior of the at least one computer system.

22. The intrusion response method of claim 19, further comprising retraining at least one of the ML models based on the behavior of the target computer system and the output response.

23. The intrusion response method of claim 19, further comprising updating the knowledge based on the behavior of the target computer system and the output response.

24. The intrusion response method of claim 19, wherein the behavior of the target computer system comprises at least one of network activity within a network or a sensor activation of a sensor.

25. A non-transitory computer-readable storage medium storing thereon a program for carrying out the method of claim 20.
